(19) United States
(12) Patent Application Publication
(10) Pub. No.: US 2014/0370489 A1
(43) Pub. Date: Dec. 18, 2014

(54) PROCESSING APPARATUS, PROCESSING SYSTEM, AND PROCESSING METHOD

(71) Applicant: FUJITSU LIMITED, Kawasaki-shi (JP)

(72) Inventors: Hidehiko Mayumi, Kawasaki (JP); toshio tanaka, Yokohama (JP); Takeaki Kobayashi, Yokohama (JP); Kenji Sakata, Shinagawa (JP)

(73) Assignee: FUJITSU LIMITED, Kawasaki-shi (JP)

(21) Appl. No.: 14/271,759

(22) Filed: May 7, 2014

(30) Foreign Application Priority Data
Jun. 12, 2013 (JP) 2013-124008

(51) Int. Cl. G09B 5/02

(52) U.S. Cl. CPC G09B 5/02
USPC 434/365

(57) ABSTRACT

A presenter narrowing apparatus includes: a display unit configured to display one or more opinions input from each of a plurality of terminals; and an instruction unit configured to instruct a terminal, in which an opinion other than a designated opinion among opinions that belong to a certain group is input, to display a screen in which each of a plurality of items related to relevancy to the designated opinion is selectable when the opinion which belongs to the certain group among at least one group formed by being classified from opinions displayed in the display unit is designated. In the presenter narrowing apparatus, the instruction unit allows the display unit to highlight an opinion input to a terminal, for which a timing at which one item among the plurality of items is selected satisfies a predetermined criterion, among the opinions that belong to the certain group.

### CROSS-REFERENCE TO RELATED APPLICATION

This application is based upon and claims the benefit of priority from the prior Japanese Patent Application No. 2013-124008 filed on Jun. 12, 2013, the entire contents of which are incorporated herein by reference.

### FIELD

The embodiments discussed herein are related to a processing apparatus, a processing system and a processing method that support teaching operations in conducting a class.

### BACKGROUND

Multi-point conferences have been available using a plurality of information processing terminals connected with each other through a network.

In the multi-point conference using the information processing terminals, for example, a technique has been proposed in which the priority level of right to speak is calculated using a function which has one or more of combinations of the attributes of conference participants (e.g., a social status, an official post and rank, and a specialized field), a speech accumulated time, and the number of speech times, as variables in order to smoothly advance a multi-point conference according to the purpose thereof.

See, for example, Japanese Laid-open Patent Publication No. 08-274888.

Next-generation type educations using the information processing terminals by the teachers and students have recently been conducted in educational institutions of elementary and secondary schools.

A visual discussion support system has been provided for the next-generation type education. A class is conducted in such a manner that an assignment is transmitted from a teacher's terminal to a student's terminal and each student inputs an opinion for the assignment at the student's terminal to reply to the teacher's terminal. The opinions of respective students are collected in the teacher's terminal, and opinions and approvals or disapprovals of all the students are displayed in a form of a matrix shape on a screen, which serves as a shared screen between the teacher and students in a classroom. Also, the teacher allows each student to present his/her opinion regarding other opinions input by other students.

Here, when all of the students (e.g., several tens of students) in a class present their opinions, the same opinions may be included in the presented opinions and thus, the contents of presented opinions may be overlapped between the opinions and may cause waste of time, which is problematic. Accordingly, it is efficient for conducting a class to allow only a representative to present an opinion regarding the same opinions.

In the meantime, in the conventional technology described above, a speaker is determined among a plurality of participants based on a priority level of a right to speak in accordance with a purpose of the conference but a representative speaker for the same opinions may not be determined among the collected opinions for the assignment.

Therefore, even when the conventional technology described above is used in the next generation type education, it is difficult to grasp contents of several tens of opinions collected from respective students in a class for a short time and thus, a presenter may not be selected efficiently. Further, among the students, there may be a student who tries to avoid presentation by replying to the teacher's terminal that “I have the same opinion as that of Mr. XX”, in spite of that the student has a different focus on the assignment. There is a problem that such a student cannot be determined.

One aspect of the present disclosure intends to determine and exclude a student who has the truly same opinion as that of a presenter, thereby narrowing presenter candidates who have different opinions.

### SUMMARY

According to an aspect of the embodiment, a presenter narrowing apparatus includes: a display unit configured to display one or more opinions input from each of a plurality of terminals; and an instruction unit configured to instruct a terminal, in which an opinion other than a designated opinion among opinions that belong to a certain group is input, to display a screen in which each of a plurality of items related to relevancy to the designated opinion is selectable when the opinion which belongs to the certain group among at least one group formed by being classified from opinions displayed in the display unit is designated. In the presenter narrowing apparatus, the instruction unit allows the display unit to highlight an opinion input to a terminal, for which a timing at which one item among the plurality of items is selected satisfies a predetermined criterion, among the opinions that belong to the certain group, compared to the other opinions that belong to the certain group.

Further, the object to be solved may be accomplished by a presenter narrowing system, a presenter narrowing method, a computer executable presenter narrowing program that, when executed, causes a computer to function as the presenter narrowing apparatus, or a computer readable storage medium storing the computer executable presenter narrowing program.

The object and advantages of the disclosure will be realized and attained by means of the elements and combinations particularly pointed out in the claims. It is to be understood that both the foregoing general descriptions and the following detailed descriptions are exemplary and explanatory, and are not restrictive of the invention, as claimed.

According to an aspect of the embodiment, it is possible to determine and exclude a student who has the truly same opinion as that of a presenter to narrow presenter candidates who have different opinions

### BRIEF DESCRIPTION OF DRAWINGS

FIG. 1 is a view illustrating an exemplary configuration of a presenter narrowing system according to an embodiment of the present disclosure.

FIG. 2 is a view illustrating an exemplary hardware configuration of a server.

FIG. 3 is a view illustrating a display example of an opinion input screen.

FIG. 4 is a view illustrating a display example in which opinions of all the students are displayed in a shared screen.

FIG. 5 is a view illustrating an example of opinion displayed in an enlarged scale.

FIG. 6 is a view illustrating a display example of the same opinion communication screen.

FIG. 7 is a view illustrating a display example of an attention screen.

FIG. 8 is a view illustrating a masking display example.

FIG. 9A and FIG. 9B are flowcharts for explaining a presenter narrowing process.

FIG. 10 is a flowchart for explaining a determination process at step S78 of FIG. 9B.

FIG. 11 is a view for explaining a determination process at step S78 of FIG. 9B.

FIG. 12 is a view illustrating an exemplary data configuration of a student database, an assignment database and a threshold value database.

FIG. 13 is a view illustrating an exemplary data configuration of an opinion database.

### DESCRIPTION OF EMBODIMENTS

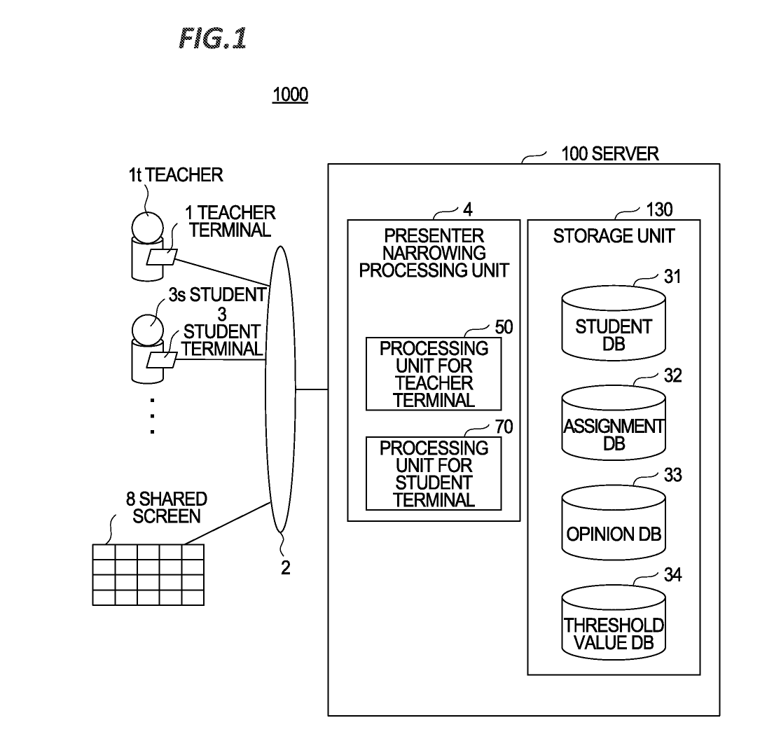

Hereinbelow, exemplary embodiments of the present disclosure will be described with reference to the drawings. FIG. 1 is a view illustrating an exemplary configuration of a discussion support system according to an embodiment of the present disclosure. In FIG. 1, a presenter narrowing system 1000 according to the embodiment includes a server 100, a teacher terminal 1, a plurality of student terminals 3 and a shared screen 8.

The shared screen 8 is a screen referenced by a teacher 1t and a student 3s. The shared screen 8 may be a screen projected onto a screen in a classroom through a projector. The server 100, the teacher terminal 1, the plurality of student terminals 3, and the projector are connected with each other through a network 2. In the configuration illustrated in FIG. 1, each of the server 100 and the teacher terminal 1 exemplified as a separate computer apparatus, but may be incorporated into a single computer apparatus.

The teacher terminal 1 is a computer apparatus and is used by the teacher lt. The student terminal 3 is a computer apparatus and used by each student 3s. Each of the teacher terminal 1 and the student terminal 3 includes a control unit formed by a CPU, a display unit, an input unit and a communication unit. The display unit may be a touch panel type display unit which is also equipped with an input function. In this case, the input unit may be omitted.

The shared screen 8 is a screen projected onto a screen in a classroom and referenced by the teacher 1t and a plurality of students 3s in the classroom, and corresponds to the display unit. The display content of the shared screen 8 is controlled by the server 100. Further, the same contents of display as that of the shared screen 8 are also displayed on the teacher terminal 1 by the server 100.

The server 100 is a computer apparatus and includes a presenter narrowing processing unit 4 and a storage unit 130. The server 100 corresponds to the presenter narrowing apparatus. The presenter narrowing processing unit 4 is implemented by a presenter narrowing application installed in the server 100 and corresponds to an instruction unit which manages and controls the entirety of the presenter narrowing system 1000. The teacher terminal 1 and each student terminal 3 use the presenter narrowing application through the network 2.

The presenter narrowing processing unit 4 refers to an opinion DB 33 in which opinions and approvals or disapprovals for an assignment transmitted from the student terminals 3 are collected to determine students who have the truly same opinion among the students who claimed as having the same opinion for the assignment. The presenter narrowing processing unit 4 further includes a processing unit for teacher terminal 50 and a processing unit for student terminal 70. The processing unit for teacher terminal 50 corresponds to a first instruction unit which controls the processes related to the teacher terminal 1 and the shared screen 8. The processing unit for student terminal 70 corresponds to a second instruction unit which controls the processes related to the student terminal 3.

The processing unit for teacher terminal 50 performs the processing for the teacher terminal 1 and also determines students who have the truly same opinion. A user interface, for displaying information for the teacher 1t on the teacher terminal 1 and also for receiving input by the teacher 1t, is displayed on the teacher terminal 1 by the processing unit for teacher terminal 50. The processing unit for teacher terminal 50 performs a processing according to an input onto the teacher terminal 1 by the teacher lt.

The processing unit for student terminal 70 performs the processing for the student terminal 3 and at the same time determines whether a time consumed for hearing an opinion of the presenter was appropriate in order to determine a student who has the truly same opinion. A user interface, for displaying information for the student on the student terminal 3 and also for receiving input by the student 3s, is displayed on the teacher terminal 1 by the processing unit for student terminal 70. The processing unit for student terminal 70 performs a processing according to an input onto the student terminal 3 by the student 3.

A time spanning from start of presentation of the presenter to input of the opinion and the approval or disapproval by the student 3s is measured by the processing unit for student terminal 70.

The shared screen 8 is a screen projected onto, for example, a screen in the classroom by the control of the presenter narrowing processing unit 4.

A student DB 31 is a database in which student information such as a student name is stored by being associated with every student ID. An assignment DB 32 is a database in which an assignment prepared by the teacher 1t in advance is stored by being associated with every assignment ID. An opinion DB 33 is a database in which, for example, selection of the approval or disapproval or the opinion of each student is stored by being associated with every assignment ID, and further stores determination information for determining the students who have the truly same opinion. A threshold value DB 34 is a database in which condition information for determining the students who have the truly same opinion.

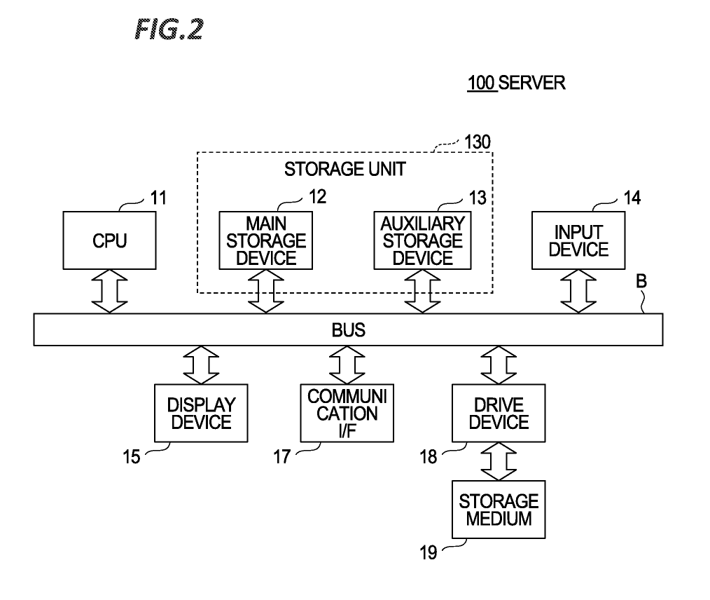

FIG. 2 is a view illustrating an exemplary hardware configuration of a server. In FIG. 2, the server 100 is a terminal controlled by a computer, and includes a CPU (Central Processing Unit) 11, a main storage device 12, an auxiliary storage device 13, an input device 14, a display device 15, a communication interface (UF) 17 and a drive device 18, all connected to a bus B.

The CPU 11 controls the server 100 according to a program stored in the main storage device 12. For example, RAM (Random Access Memory) or ROM (Read Only Memory) is used in the main storage device 12 and a program executed in the CPU 11, data necessary for processing in the CPU 11 or data obtained by processing in the CPU 11 are stored in the main storage device 12. Further, a portion of memory region of the main storage device 12 is allocated as a work area used for the processing in the CPU 11.

A hard disk drive is used for the auxiliary storage device 13 and data such as programs for executing various processings are stored in the auxiliary storage device 13. A portion of the program stored in the auxiliary storage device 13 is loaded to the main storage device 12 and is executed by the CPU 11 and thus, various processings are implemented. The storage unit 130 includes the main storage device 12 and/or the auxiliary storage device 13.

The input device 14 is equipped with, for example, a mouse or keyboard, and is used for inputting various information necessary for the processing by the server 100 by an operational manager or a teacher. The display device 15 displays various information required for the processings under the control of the CPU 11. The communication I/F 17 is an apparatus for connecting to, for example, the Internet or a LAN (Local Area Network) to control a communication between, for example, the teacher terminal 1 and the student terminal 3. The communication by the communication I/F 17 is not limited to wired or wireless communication.

The program implementing the processing performed by the server 100 is provided to the server 100 by the storage medium 19, such as a CD-ROM (Compact Disc Read-Only Memory).

The drive device 18 performs an interface with the storage medium 19 (e.g., CD-ROM) set in the drive device 18 and the server 100.

Further, a program which implements a presenter narrowing process according to the embodiment to be described below is stored in the storage medium 19 and the program stored in the storage medium 19 is installed in the server 100 through the drive device 18. The installed program becomes executable by the server 100.

In the meantime, a medium storing the program is not limited to the CD-ROM and may include any type of computer readable medium. The computer readable medium may include a DVD disk, a portable recording medium such as a USB memory, or a semiconductor memory such as a flash memory, in addition to the CD-ROM.

Before explaining a specific processing flow, the presenter narrowing process according to the embodiment will be outlined with reference to screen examples of the teacher terminal 1, the student terminal 3, and the shared screen 8.

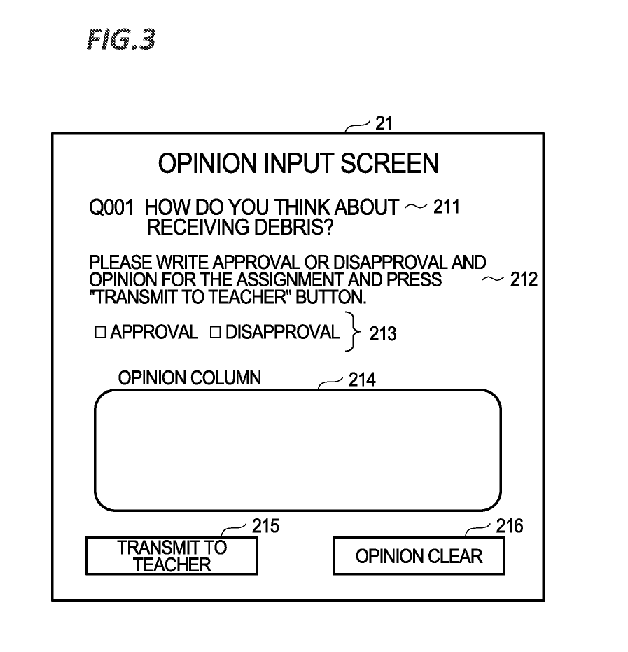

FIG. 3 is a view illustrating a display example of an opinion input screen. The opinion input screen 21 illustrated in FIG. 3 is displayed in a display unit of the student terminal 3. The opinion input screen 21 includes an assignment 211, an instruction content 212, an approval or disapproval selection 213, an opinion column 214, a “Transmit to teacher” button 215, and an “Opinion clear” button 216.

The assignment 211 indicates an assignment designated by the teacher lt. The instruction content 212 designates matters that cause the student 3s to perform an action in the opinion input screen 21. In this example, “Q001 How do you think about receiving debris?” is displayed in the assignment 211. Further, the instruction content 212 indicates, for example, “Please write the approval or disapproval and the opinion for the assignment described above and press the “Transmit to teacher” button.”

The approval or disapproval selection 213 is an area for allowing the student 3s to select either an approval or disapproval for the assignment 211. The opinion column 214 is an input area into which the student 3s may input the opinion. The student 3s inputs the opinion for the assignment 211 into the opinion column 214.

The “Transmit to teacher” button 215 is a button for transmitting the result of approval or disapproval selected in the approval or disapproval selection 213 for the assignment 211 and an opinion input into the opinion column 214 by the student 3s. The result of approval or disapproval and the opinion are transmitted from the student terminal 3 to the server 100 in response to the pressing of the “Transmit to teacher” button 215.

The “Opinion clear” button 216 is a button for returning the result of the approval or disapproval selected in the approval or disapproval selection 213 for the assignment 211 and opinion input into the opinion column 214 by the student 3s to an initial state. The student 3s may press the “Opinion clear” button 216 to return the approval or disapproval selection 213 and the opinion column 214 to the initial state in order to perform a re-selection of the approval or disapproval and re-input of the opinion again.

The result of the approval or disapproval and opinion transmitted from the student terminal 3 are stored in the opinion DB 33 within the storage unit 130 of the server 100.

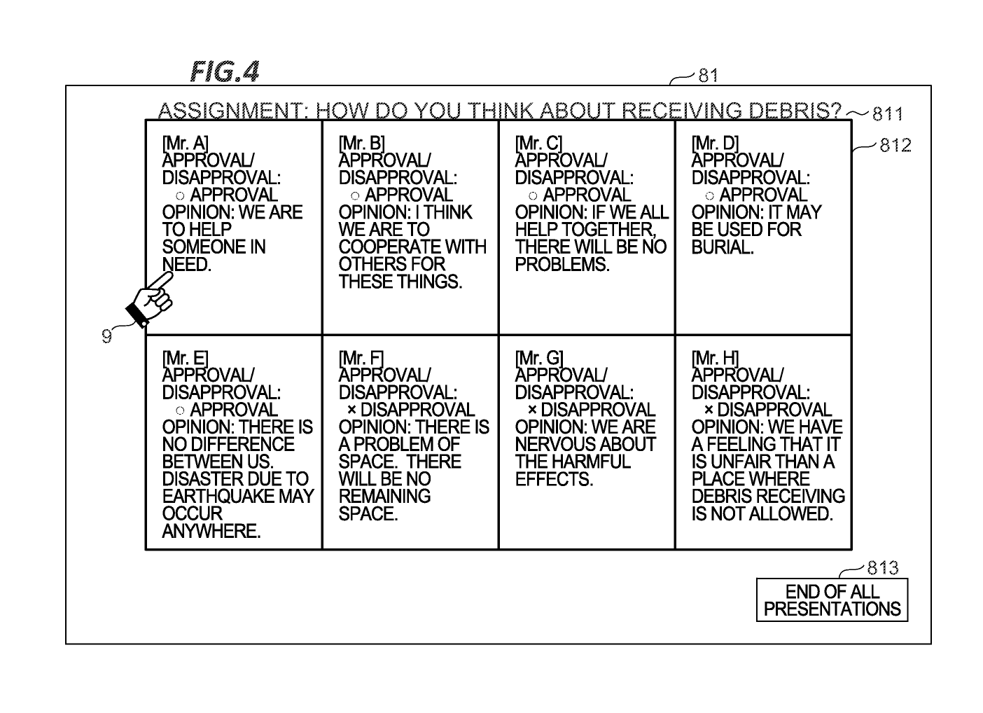

FIG. 4 is a view illustrating a display example in which opinions of all the students are displayed in a shared screen. A display content 81 of the shared screen 8 illustrated in FIG. 4 includes an assignment 811, an opinion list 812, and an “End of all presentations” button 813.

The assignment 811 indicates an assignment designated by the teacher lt. In this example, “Assignment: How do you think about receiving debris?” is displayed in the assignment 811. The opinion list 812 displays the contents of the opinions of all the students 3s.

When the number of students in a class is forty (40), forty (40) contents of opinions are displayed, but in this example, a case where the number of all the students in a class is eight (8) is indicated in order to simplify descriptions. The results of approval or disapproval and the opinions of respective students A, B, C, D, E, F, G and H are displayed. The students A, B, C, D and E indicate an opinion of “∘ approval” for the assignment 811. In the meantime, the students F, G and H indicate an opinion of “x disapproval” for the assignment 811.

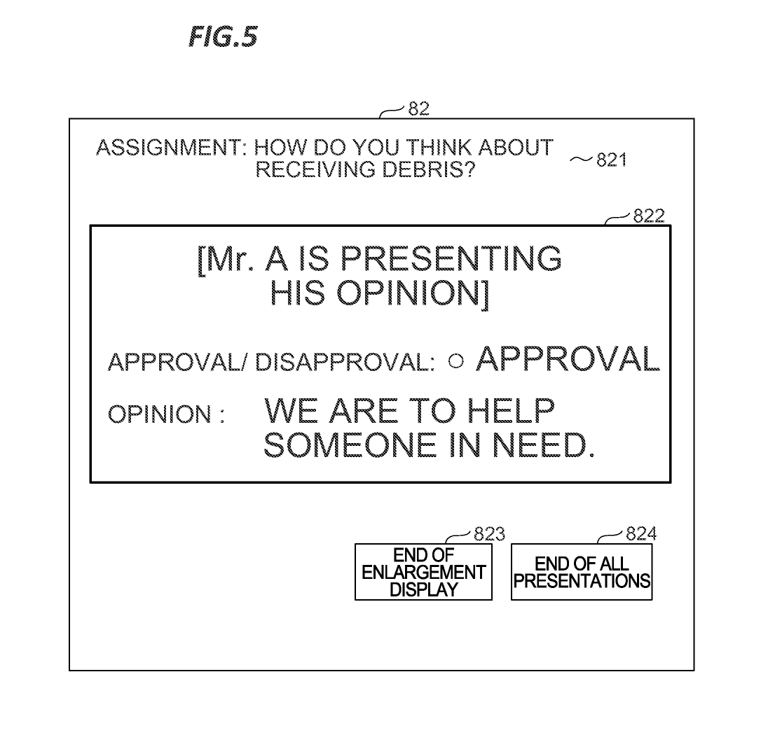

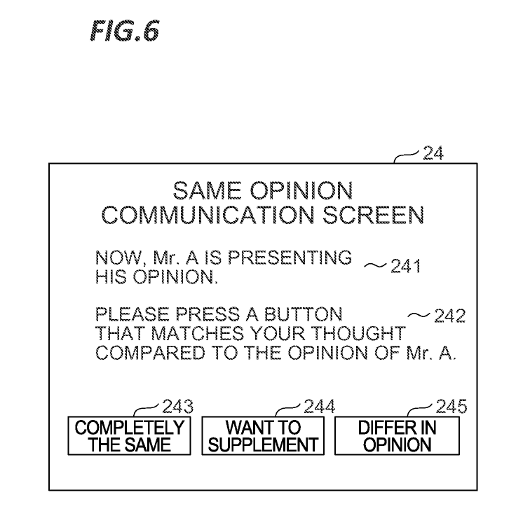

When the teacher 1t designates an opinion of any student from the opinion list 812 of the display content 81 displayed in the teacher terminal 1 using a pointer 9 in the teacher terminal 1, the processing unit for teacher terminal 50 of the server 100 displays the opinion of the designated student in the shared screen 8 in an enlarged scale (FIG. 5) and displays a same opinion communication screen (FIG. 6) in the student terminal 3 of other students who transmit the same opinion as that of the designated student.

A similarity determination between the designated opinion and each of other different opinions may be performed using conventional document similarity determination method. The opinions determined as the same as the designated opinion are grouped. The grouped opinions may be displayed in a different color for each group to allow the group to be easily discerned.

In this example, it is assumed that the teacher 1t has designated the student A. Here, the opinions of the students B, C, D and E are determined as the same as the opinion of the student A and grouped in the same opinion group. The same opinion communication screen (FIG. 6) is displayed in the student terminals 3 of the students B, C, D and E who transmit the same opinion as that of the designated student.

The “End of all presentations” button 813 is a button which is pressed in the display content 81 displayed in the teacher terminal 1 by the teacher 1t when the teacher 1t determines that all presentations for the assignment 811 are ended.

When the teacher 1t designates the student A from the opinion list 812, the opinion of the student A is displayed in an enlarged scale in the shared screen 8 as illustrated in FIG. 5. FIG. 5 is a view illustrating an example of opinion displayed in an enlarged scale. The display content 82 illustrated in FIG. 5 are the contents displayed in the shared screen 8 in an enlarged scale when the teacher 1t has designated the opinion of the student A, and includes an assignment 821, an opinion 822, an “End of enlargement display” button 823, and an “End of all presentations” button 824. Further, the display content 82 is also displayed in the teacher terminal 1. The display content 82 is not displayed in the student terminal 3.

The assignment 821 indicates an assignment designated by the teacher lt. In this example, an “Assignment: How do you think about receiving debris?” is displayed in the assignment 821. The opinion 822 indicates that the student A is presenting his opinion, and indicates the result of approval or disapproval and the opinion of the student A.

The “End of enlargement display” button 823 is a button for ending displaying of the display content 82. In a case where a presentation of the student A is ended, when the teacher 1t presses the “End of enlargement display” button 823 from the display content 82 displayed in the teacher terminal 1, the processing unit for teacher terminal 50 of the server 100 ends displaying of the display content 82.

The “End of all presentations” button 824 is a button for ending displaying of the display content 82 and ending all presentations. In a case where a presentation of the student A is ended, when the teacher 1t presses the “End of enlargement display” button 823 from the display content 82 displayed in the teacher terminal 1, the processing unit for teacher terminal 50 of the server 100 ends displaying of the display content 82 to end all presentations.

The processing unit for teacher terminal 50 starts measuring a time from the start of displaying the opinion of the student designated by the teacher 1t and ends measuring the time in response to the pressing of the “End of enlargement display” button 823 or the “End of all presentations” button 824. Information based on the measured time is stored in the threshold value DB 34.

FIG. 6 is a view illustrating a displayed example of the same opinion communication screen. FIG. 6 illustrates a display example of the same opinion communication screen 24 in a case where the student A designated by the teacher 1t is presenting his opinion. The same opinion communication screen 24 illustrated in FIG. 6 is displayed in the display unit of the student terminals 3 of other students B, C, D and E who have transmitted the same opinion as that of the student A. The same opinion communication screen 24 includes a message 241, an instruction content 242, a “completely the same” button 243, a “want to supplement” button 244, and a “differ in opinion” button 245.

The message 241 indicates that the students designated by the teacher 1t is presenting his opinion. The instruction content 242 designates matters that cause the student 3s to perform an action according to the instruction content in the same opinion communication screen 24. In this example, a message of “Mr. A is presenting his opinion now” is displayed in the message 241. Further, the instruction content 242 indicates, for example, “Please press a button that matches your thought compared to the opinion of Mr. A.”

The “completely the same “button 243 is a button for notifying that the student 3s has the completely same opinion as that of Mr. A who is presenting his opinion. The “want to supplement” button 244 is a button for notifying that the student want to supplement the opinion of Mr. A who is presenting his opinion. The “differ in opinion” button 245 is a button for notifying that the student 3s has an opinion different from that of Mr. A who is presenting his opinion.

In this example, when the student A is designated by the teacher 1t, the students B, C, D and E other than the student A in the same group are determined as candidates having the same opinion. The same opinion communication screen 24 is displayed in the student terminals 3 of the students B, C, D and E that are the candidates having the same opinion. The same opinion communication screen 24 is not displayed in the terminals 3 of the students F, G and H that do not have the same opinion as that of the student A, that is, do not belong to the same group as a group to which the student A belongs. Further, even when a student belongs to the same group as the group to which the student A belongs, the same opinion communication screen 24 is not displayed in the terminal 3 of the student for which the same opinion flag (described later) is set as “9”, “1” or “2”.

It is assumed that the students B, C, D and E have performed the following manipulation: • The student B has pressed the “completely the same” button 243. • The student C has pressed the “completely the same” button 243 intending to avoid his presentation. • The student D did not press any button. • The student E has pressed the “want to supplement” button 244. In the meantime, the student who has pressed the “differ in opinion” button 245 may be handled as a student who has an opinion which is not the same opinion as that of the student A.

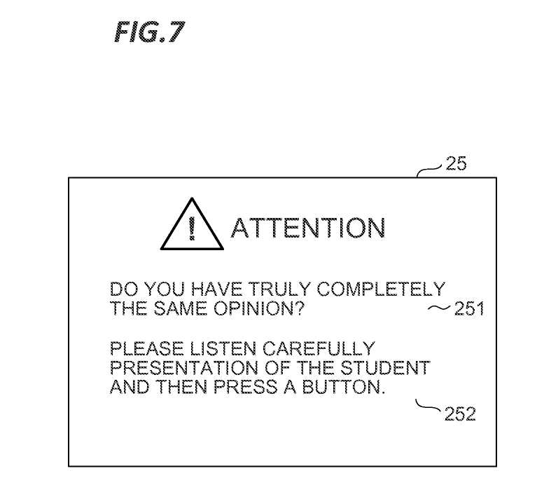

The attention screen 25 as illustrated in FIG. 7 may be displayed in the display unit of the student terminal 3 of the student C who has pressed the “completely the same” button 243 intending to avoid his presentation to cause the student C to select the button 243, 244 or 245 in the same opinion communication screen 24. The presence or absence of displaying the attention screen 25 may be set by the teacher 1t in advance. Otherwise, a value that does not display the attention screen 25 may be set as a default value. The attention screen 25 may be desirably displayed in a case where the teacher 1t may set the presence of displaying the attention screen 25.

FIG. 7 is a view illustrating a displayed example of an attention screen. The attention screen 25 illustrated in FIG. 7 is a screen for inquiring the student 3s of whether he has truly completely the same opinion as the opinion presented by the student A in order for the student 3s to select the button 243, 244 or 245 in the same opinion communication screen 24. The attention screen 25 includes, for example, a message 251 or an instruction content 252.

The message 251 is a message in order for the student 3s to confirm that he has truly the “completely the same” opinion. The instruction content 252 designates matters that cause the student 3s to perform an action according to the instruction content. In this example, “Do you have truly completely the same opinion?” is displayed in the message 251. Further, the instruction content 252 indicates, for example, “Please listen carefully presentation of the student and then press a button.”

The student who has pressed the “completely the same” button 243 for the presentation of the student A selects the button 243, 244 or 245 in the same opinion communication screen 24 again.

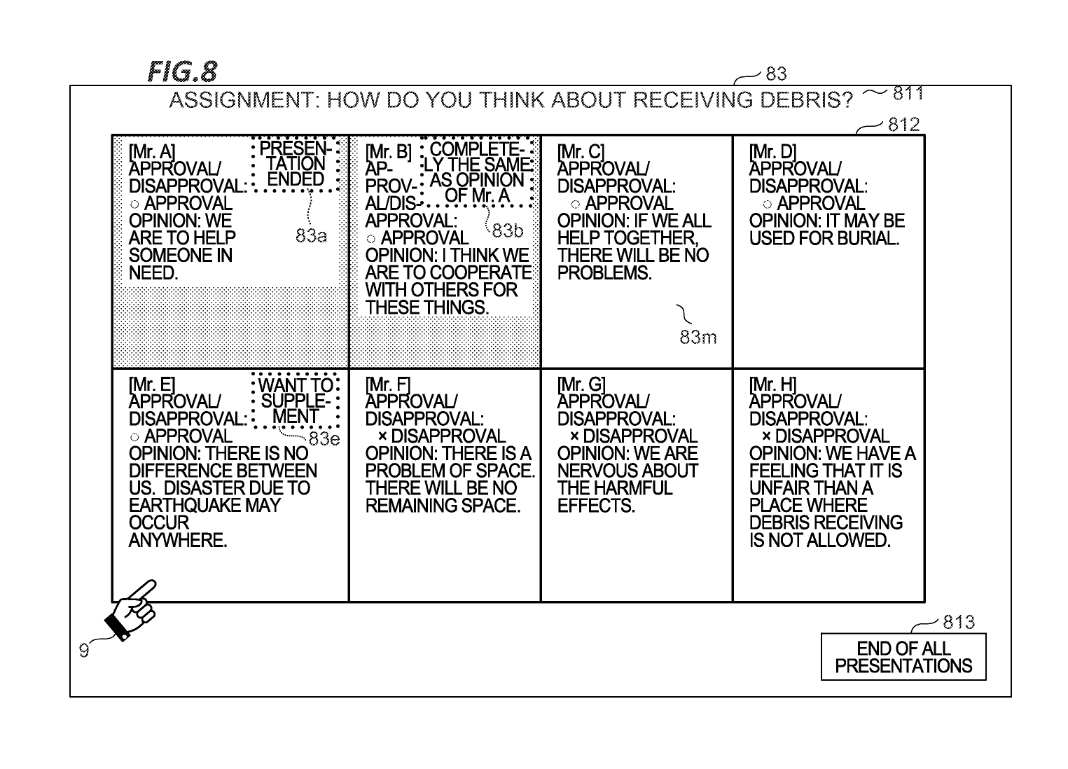

In a case where displaying the opinion of the student A in an enlarged scale is ended (FIG. 5), that is, when the presentation of the student A is ended, the display content 83 as illustrated in FIG. 8 is displayed in the shared screen 8. FIG. 8 is a view illustrating a masking display example. The display content 83 of the shared screen 8 illustrated in FIG. 8 includes, for example, the assignment 811, the opinion list 812, or an “End of all presentations” button 813 similarly to FIG. 4, and thus the description thereof will be omitted.

An auxiliary display 83a of “End of presentation” is displayed in a color, such as red color, which is different from other character color for the opinion of the student A who has ended presentation in the opinion list 812 of the display content 83.

An auxiliary display 83b is displayed in a color, such as green color, which is different from other character color for the opinion of the students who have pressed a button in the “same opinion communication screen” among the students B, C, D and E. The students who have pressed the button are the students B, C and E, but the student C who has pressed the “completely the same” button 243 determined as having a false “completely the same” opinion is excluded. The auxiliary display 83b indicating “Completely the same as the opinion of Mr. A” is displayed in the opinion of the student B and an auxiliary display 83e indicating “want to supplement” is displayed in the opinion of the student E.

The opinion of the student A designated by the teacher 1t and the opinion of the student B, who has determined that his opinion is truly “completely the same” as the opinion presented by the student A, are displayed to be masked in the opinion list 812 of the display content 83. In the meantime, the opinion 83m of the student C who has pressed the “completely the same” button 243 with the false “completely the same” opinion is not displayed to be masked and is maintained its initial display as it is similarly to those of students D, E, F, G and H.

Displaying as in the shared screen 8 is performed at the teacher terminal 1 as well. Thereafter, when the teacher 1t designates the student E using a pointer 9 in order to supplement the opinion which has been presented, the same processing as the processing for the case where the student A is designated is repeated.

As described above, in the present embodiment, in a case where a plurality of students 3s who have a similar opinion exist, a student who represents the plurality of students 3s is allowed to present the opinion and another student who has some kinds of difference to an opinion of a representative (presenter) among other students excepting the representative is allowed to present the difference as a supplementary opinion.

The student A who has presented his opinion is thought to be a representative presenter in a group to which opinions regarded as the same opinion belongs. Even in a case where the student 3s other than the representative presenter has intended to avoid his presentation by demonstrating his opinion as the “completely the same” opinion though the student 3s actually has a different opinion from the opinion of the representative presenter, the student 3s who has an opinion different from the opinion of the representative presenter may be automatically determined.

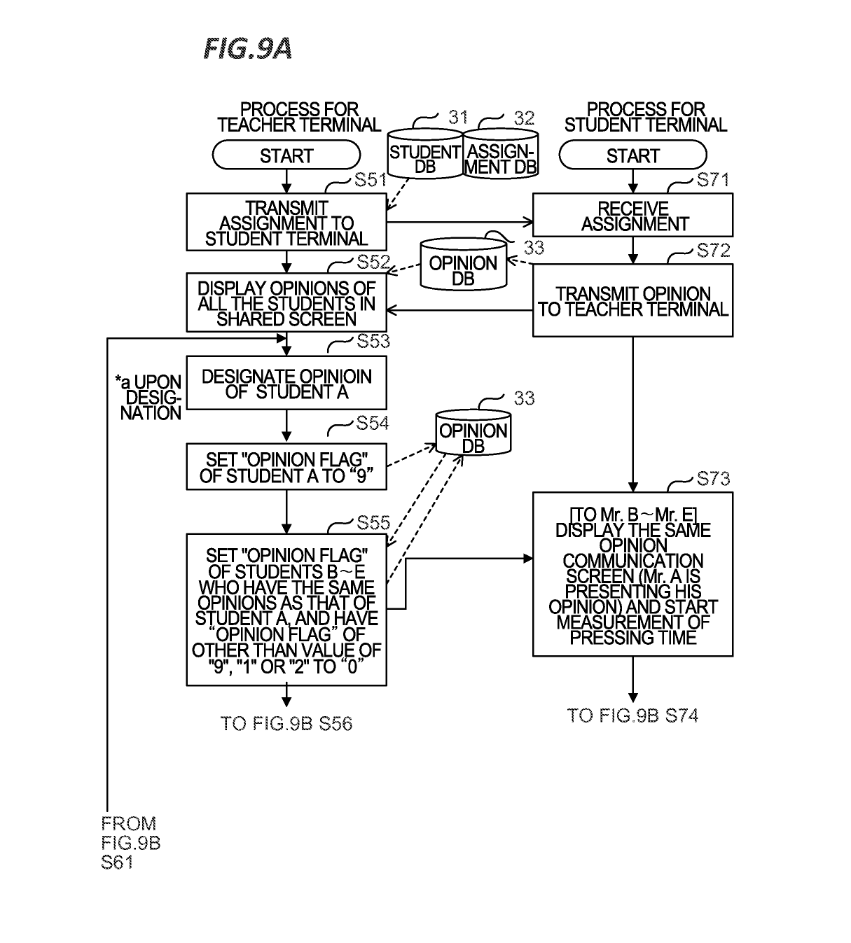

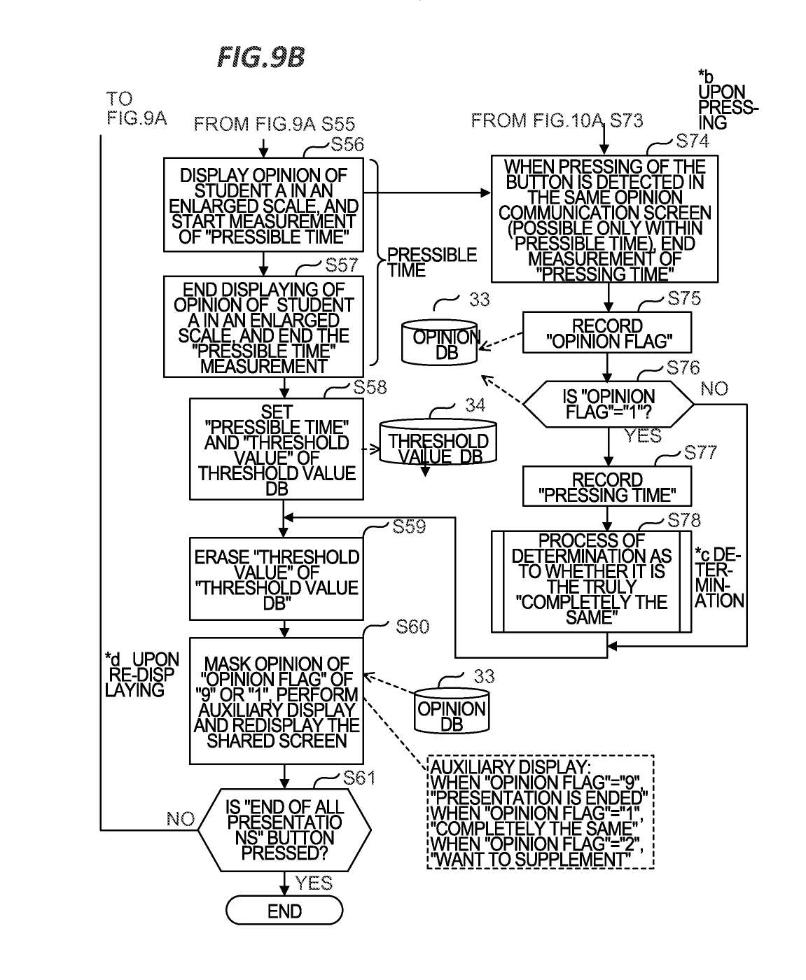

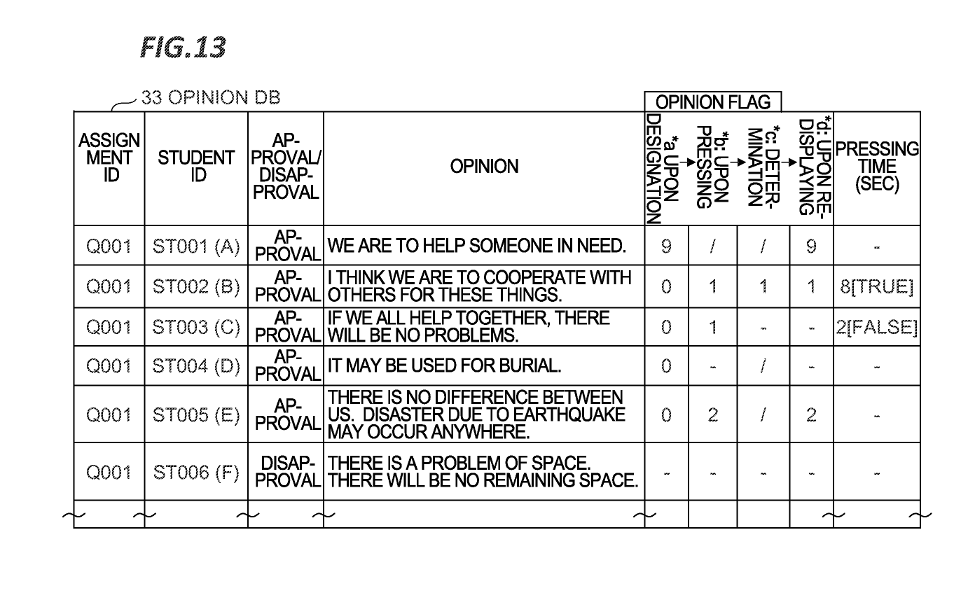

A presenter narrowing process by the presenter narrowing processing unit 4 in the server 100 as described above will be described with reference to FIG. 9A and FIG. 9B. FIG. 9A and FIG. 9B are flowcharts for explaining a presenter narrowing process. In FIG. 9, the processes from step S51 to step S61 correspond to the processes to be performed by the processing unit for teacher terminal 50. Further, the processes from step S71 to step S78 correspond to the processes to be performed by the processing unit for student terminal 70. In FIG. 9A and FIG. 9B, explanatory notes of *a, *b, *c and *d correspond to change of an “opinion flag” value illustrated in FIG. 13.

When the teacher 1t selects an assignment among the assignments stored in the assignment DB 32, the processing unit for teacher terminal 50 transmits the assignment selected by the teacher 1t to the student terminal 3 of the student 3s registered in the student DB 31 (step S51).

The processing unit for student terminal 70 receives the assignment (step S71). The opinion input screen 21 as illustrated in FIG. 3 is displayed in the student terminal 3 by the processing unit for student terminal 70. The student 3s selects an approval or disapproval for the assignment and inputs an opinion in the opinion input screen 21, and transmits the selected approval or disapproval and the input opinion to the teacher 1t (step S72). Further, the processing unit for student terminal 70 associates the result of the selected approval or disapproval and the input opinion with a student ID to be stored in the opinion DB 33.

The processing unit for teacher terminal 50 refers to the opinion DB 33 to display the opinions of all the students (FIG. 4) in the shared screen 8 (step S52). The opinions of all the students (FIG. 4) are also displayed in the teacher terminal 1.

When the teacher 1t designates an opinion of a student A from the opinion list 812 (FIG. 4) (step S53), the processing unit for teacher terminal 50 sets an “opinion flag” of the student A in the opinion DB 33 as “9” (step S54).

The processing unit for teacher terminal 50 refers to the opinion DB 33 to set the “opinion flag” of the students B, C, D and E, that belong to the group regarded as a group to which the same opinions as that of the student A belong and have the “opinion flag” indicated as a value other than a value of “9”, “1” or “2”, as “0 (zero)” (step S55). Further, the processing unit for teacher terminal 50 instructs the processing unit for student terminal 70 to display the same opinion communication screen 24 (FIG. 6) in the student terminals 3 of the students B, C, D and E.

The processing unit for student terminal 70 displays the same opinion communication screen 24 (FIG. 6) in the student terminals 3 of the students B, C, D and E according to the instruction to display to start measurement of a pressing time (step S73). Step S73 to step S78 are performed for each of the student terminal 3 of the students B, C, D and E.

The processing unit for teacher terminal 50 displays the opinion of the student A in the shared screen 8 in an enlarged scale (FIG. 5) and starts measurement of “pressible time” (step S56). Also, when the presentation of the student A is ended, the processing unit for teacher terminal 50 ends displaying the opinion of the student A in an enlarged scale in the shared screen 8 (FIG. 5), and ends the measurement of “pressible time” (step S57).

Also, the processing unit for teacher terminal 50 sets a “pressible time” field and “threshold value” field of a threshold value DB 34 (step S58). The processing unit for teacher terminal 50 sets the “pressible time” measured at step S56 and S57 in the “pressible time” of the threshold value DB 34. Further, the processing unit for teacher terminal 50 refers to the threshold value DB 34 to acquire a condition value set in a “threshold value set condition” of the threshold value DB 34 in advance to calculate a threshold value using the measured “pressible time” and the acquired condition value. The calculated threshold value is set in the “threshold value” of the threshold value DB 34.

In the meantime, each of the students B, C, D and E presses any one of the buttons 243, 244, 245 in the same opinion communication screen 24 (FIG. 6) displayed in the student terminal 3. When the pressing of the button is detected, the processing unit for teacher terminal 50 ends the measurement of “pressing time” (step S74). The students B, C, D and E may select the button in the same opinion communication screen 24 (FIG. 6) only during displaying an opinion in an enlarge scale (FIG. 5), that is, within the pressible time.

The processing unit for student terminal 70 records the “opinion flag” associated with the student ID of each of the students B, C, D and E of the opinion DB 33 (step S75). Manipulations for the “opinion flag” are as follows. • When the “completely the same” button 243 is pressed, the “opinion flag” in the opinion DB 33 is set as “1”. • When the “want to supplement” button 244 is pressed, the “opinion flag” in the opinion DB 33 is set as “2”. • When the “differ in opinion” button 245 is pressed, the “opinion flag” in the opinion DB 33 is set as “0”.

The processing unit for student terminal 70 determines whether the “opinion flag” indicates “1” (step S76). When it is determined that the “opinion flag” does not indicate “1”, a process in the processing unit for student terminal 70 is ended. Otherwise, when the “opinion flag” indicates “1”, the processing unit for student terminal 70 records the pressing time measured at step S73 and step S74 in the “pressing time” of the opinion DB 33 and performs a process of determination as to whether it is the truly “completely the same” opinion (step S78), and the process in the processing unit for student terminal 70 is ended.

In response to the end of the process in the processing unit for student terminal 70, the processing unit for teacher terminal 50 erases “threshold value” of the threshold value DB 34 (step S59), and refers to the opinion DB 33 to mask the opinion of the student who has the “opinion flag” indicating the number of “9” or “1” and perform an auxiliary display depending on the selection of the button in the same opinion communication screen 24 (FIG. 6) of the students B, C, D and E, thereby redisplaying the shared screen 8 (step S60).

The auxiliary displays indicates that when the “opinion flag” is the number “9”, the opinion is “presentation is ended”, when the “opinion flag” is the number of “1”, the opinion is “completely the same”, and when the “opinion flag” is the number of “2”, the opinion is “want to supplement”.

The processing unit for teacher terminal 50 determines whether the “End of all presentations” button 813 or 824 is pressed by the teacher 1t (step S61). When pressing of the “End of all presentations” the button 813 or 824 is not detected, the processing unit for teacher terminal 50 returns to step S53, and repeats the processes described above. Further, the processes by the processing unit for student terminal 70 are repeated by being associated with the processes by the processing unit for teacher terminal 50.

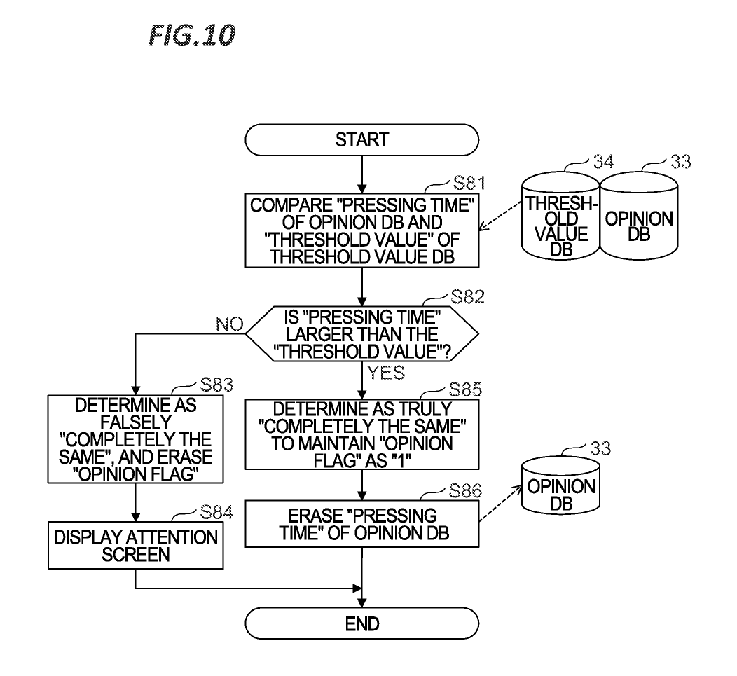

FIG. 10 is a flowchart for explaining the determination process at step S78 of FIG. 9B. In FIG. 10, the processing unit for student terminal 70 compares the “pressing time” associated with the student ID of the opinion DB 33 and the “threshold value” of the threshold value DB 34 (step S81). The processing unit for student terminal 70 determines whether the “pressing time” is larger than the “threshold value” (step S82).

When it is determined that the “pressing time” is equal to or less than the “threshold value”, the processing unit for student terminal 70 determines that an opinion expressed by the corresponding student corresponds to a falsely “completely the same” opinion, erases the “opinion flag” of the student (step S83), displays an attention screen 25 (FIG. 7) (step S84) in the student terminal 3, and ends the determination process.

In the meantime, when it is determined that the “pressing time” is larger than the “threshold value”, the processing unit for student terminal 70 determines that an opinion expressed by the corresponding student corresponds to a truly “completely the same” opinion as the presenter's opinion, maintains the “opinion flag” in the number of “1” as it is (step S85), erases the “pressing time” of the student ID of the opinion DB 33 (step S86), and ends the determination process.

When displaying of the attention screen 25 (FIG. 7) is set as absence of displaying, the processing of step S84 is omitted. The settings of presence or absence of displaying for the attention screen 25 may be changed by the teacher lt. When displaying of the attention screen 25 is set as presence of displaying of the attention screen 25, any one of the following processes is performed at step S84: • After displaying the attention screen 25 in the student terminal 3 for several seconds, the attention screen 25 is returned to the same opinion communication screen 24 (FIG. 6). • After displaying the attention screen 25 in the student terminal 3 for several seconds, clears displaying of the student's terminal 3 to cause to display nothing in the student terminal 3. • Displaying the attention screen 25 continuously until a next screen (e.g., the same opinion communication screen 24 or the opinion input screen 21 indicating a next assignment) is displayed.

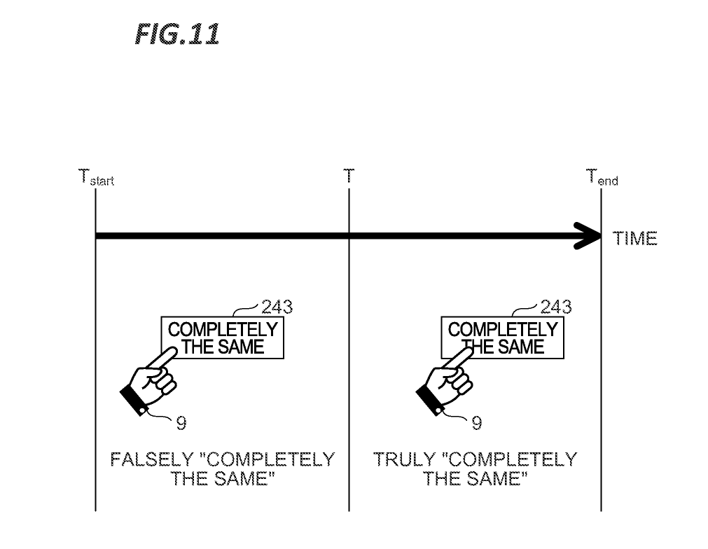

Subsequently, the determination process at step S78 of FIG. 9B will be described with reference to FIG. 11. FIG. 11 is a view for explaining the determination process at step S78 of FIG. 9B. In FIG. 11, measurement of the “pressible time” is performed by the processing unit for teacher terminal 50, and the measurement starts at a time Tstart at which the teacher 1t designates the opinion of the student A in the opinion list 812 in the display content 81 of the shared screen 8 illustrated in FIG. 4 and ends at a time Tend at which the teacher 1t presses the “End of enlargement display” button 823 of the display content 82 displayed in an enlarged scale illustrated in FIG. 5. The measured “pressible time” is set as a “pressible time” of the threshold value DB 34.

A threshold time (T) for determining the false “completely the same” opinion as the presenter's opinion is determined using the “pressible time” and the “threshold value set condition” of the threshold value DB 34. When the measured “pressible time” is 10 (ten) seconds and the “threshold value set condition” which is set in advance is 50% of the “pressible time”, 5 (five) seconds are obtained by multiplying 10 (ten) seconds by 50%. The threshold time (T) is determined as 5 seconds and the calculated 5 seconds are stored in the “threshold value” of the threshold value DB 34.

Five seconds stored in the “threshold value” of the threshold value DB 34 are the basis for determining that A student has tried to avoid performing his presentation by pressing the “completely the same” button 243 in the same opinion communication screen 24 (FIG. 6) without sufficiently listening the content of presentation of the student A, and are referenced by the processing unit for student terminal 70.

The threshold time of 5 seconds is compared with the “pressing time” measured in the student terminal 3. When the “pressing time” is shorter than 5 seconds, pressing of the “completely the same” button 243 is determined as the false “completely the same” opinion as the presenter's opinion. When the “pressing time” is longer than 5 seconds, the pressing of the “completely the same” button 243 is determined as the true “completely the same” opinion as the presenter's opinion.

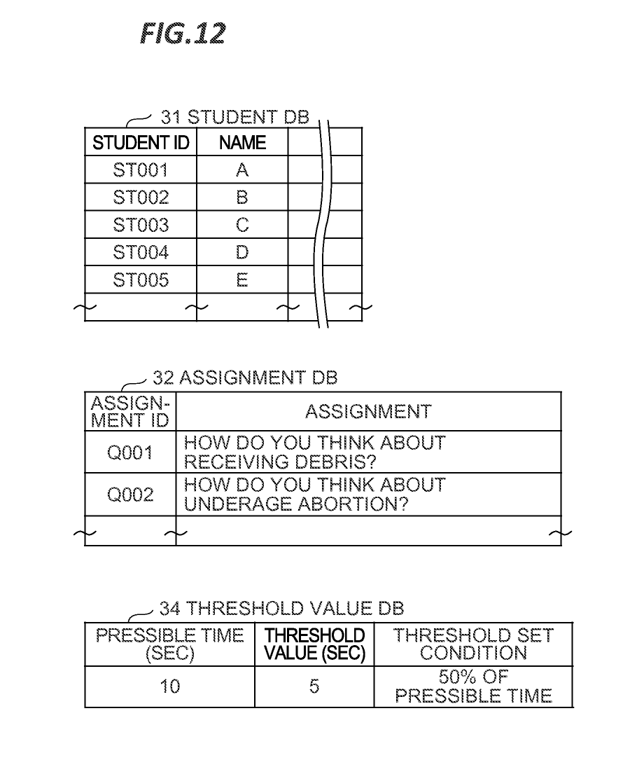

FIG. 12 and FIG. 13 are views illustrating exemplary data configuration of databases. FIG. 12 illustrates exemplary data configuration of the student DB 31, the assignment DB 32 and the threshold value DB 34 and FIG. 13 illustrates an exemplary data configuration of the opinion database 33.

The student DB 31 includes fields for student information, such as student ID or name. The student ID in the student ID field indicates identification information for specifying the student 3s and a name in the name field indicates a full name of the student 3s. In this example, the student information, such as a name “A”, is associated with the student ID of “ST001”.

The assignment DB 32 includes fields for assignment ID and assignment. An assignment ID indicates identification information for specifying an assignment and the assignment indicates the content of the assignment prepared in advance by the teacher lt. In this example, the assignment specified the assignment ID “Q001” is “How do you think about receiving debris?”.

The threshold value DB 34 includes fields for pressible time (sec) and threshold time (sec), and threshold value set condition. A pressible time (sec) is a period of time during which the student 3s may select one of the buttons 243, 244, 245 in the same opinion communication screen 24 displayed in the student terminal 3. The pressible time (sec) indicates a time, which is measured (at step S56 and step S57 of FIG. 9B) by the processing unit for teacher terminal 50 until displaying the opinion of the student 3s who is designated by the teacher 1t to present his opinion in an enlarged scale is ended after starting the displaying (FIG. 5), that is, a time spanning from a time Tstart to a time Tend of FIG. 11.

The threshold time (sec) is a threshold value for determining as to whether the opinion of the student 3s is either the true “completely the same” opinion or the false “completely the same” opinion as the presenter's opinion in a case where the student 3s has pressed the “completely the same” button 243 from the same opinion communication screen 24, and indicates the threshold time (T) of FIG. 11. The threshold time is calculated by the processing unit for teacher terminal 50 using the pressible time and the threshold value set condition which is set in advance. The threshold value set condition indicates a percentage of a time, which is taken to determine a difference between a content of presentation and the student 3s′ opinion by the student 3s, with respect to the pressible time, and is set in advance by the teacher lt.

As described above, the threshold value is represented by a percentage of the pressible time and thus, it is possible to determine whether the student 3s has pressed the “completely the same” button 243 after sufficiently listening the content of presentation in accordance with a length of presentation time, that is, the true “completely the same” opinion or the false “completely the same” opinion as the presenter's opinion.

In FIG. 13, the opinion DB 33 includes fields for assignment ID, student ID, approval or disapproval, opinion, opinion flag, pressing time (sec). The assignment ID indicates an assignment ID registered in the assignment DB 32. The student ID indicates a student ID registered in the student DB 31. In this example, student name is indicated in the “( )” in addition to the student ID, but the student name may be omitted.

The approval or disapproval field indicates the result of approval or disapproval selected by the student 3s about the assignment in the opinion input screen 21 (FIG. 3). The opinion field indicates an opinion input by the student 3s about the assignment in the opinion input screen 21.

The opinion flag field indicates an opinion transition of the student 3s regarding the presentation. In FIG. 13, a value of an opinion flag in the opinion flag field is indicated as a separate value for each event such as a button selection of the student 3s in order to indicate the opinion transition. Specifically, the opinion flags indicate values that are set in each state of “*a: upon designation”, “*b: upon pressing”, “*c: upon determination” and “*d: upon re-displaying” illustrated in FIG. 9A and FIG. 9B.

The pressing time (sec) indicates a time consumed by the student 3s, for comparing the content of presentation with the opinion of the student 3s. The pressing time (sec) indicates a time until the student 3s presses the “completely the same” button 243, the “want to supplement” button 244 or the “differ in opinion” button 245 in the same opinion communication screen 24 (FIG. 6) based on the comparison of the content of presentation with the opinion of the student 3s after starting of the presentation of opinion for the assignment by the presenter, and also indicates a time measured by the processing unit for student terminal 70 (step S73 of FIG. 9A and step S74 of FIG. 9B).

The opinion DB 33 illustrated in FIG. 13 indicates an example of data in a case where the student A, who is designated by the teacher 1t, having the student ID “ST001” has presented his opinion about the assignment “How do you think about receiving debris?” specified by the assignment ID. Data regarding the other assignments are stored and managed in the same configuration in the opinion DB 33.

In the example of data, the student A having the student ID “ST001” has an “approval” for the assignment and expresses an opinion of “We are to help someone in need.” (step S72 of FIG. 9A). The student A is designated by the teacher 1t as a representative presenter (“*a: upon designation”: the display content 81 of the shared screen 8 of FIG. 4 and step S53 of FIG. 9A) and thus, the number “9” is set in the opinion flag of the student A (step S54 of FIG. 9A).

Since the student A is the representative presenter, events of the “*b: upon pressing” and “*c: upon determination” do not exist in a processing for the student A. Accordingly, the opinion flag of the student A is not changed and thus, indicated as a symbol “/” for convenience of explanation. The symbol “/” indicates that the opinion flag is not changed. Accordingly, at “*d: upon re-displaying”, the opinion flag of the student A indicates the number “9” which is set at “*a: upon designation”. The opinion of the student A is masked upon redisplaying (FIG. 8) of the shared screen 8 and exempted from the next candidates for presentation.

The processing unit for teacher terminal 50 sets the opinion flag of the students B, C, D and E, who have the same opinion as that of the designated student A and the value of opinion flag other than “9”, “1” or “2”, as “0” (step S55 of FIG. 9A) according to designation of a presenter by the teacher lt. The opinion flag for other students including the student F other than the students B, C, D and E indicates the symbol “-” which indicates an unset.

The student B having the student ID “ST002” has an “approval” for the assignment and expresses an opinion of “I think we are to cooperate with others for these things.” (step S72 of FIG. 9A). Due to this opinion, the student B is determined as having the same opinion as that of the student A by the processing unit for teacher terminal 50 and thus, the opinion flag of the student B is set as “0” (*a: upon designation: step S55 of FIG. 9A).

Further, the student B selects the “completely the same” button 243 in the same opinion communication screen 24 (FIG. 6) displayed due to the determination that the student B has the same opinion as that of the student A (*b: upon pressing). The opinion flag of the student B is set as “1” by the processing unit for student terminal 70 (step S75 of FIG. 9B).

The time until the student B presses the “completely the same” button 243 after the same opinion communication screen 24 (FIG. 6) is displayed in the student terminal 3 of the student B is measured by the processing unit for student terminal 70 and the measured value is stored in the pressing time (step S77 of FIG. 9B). “eight (8)” seconds measured in the student terminal 3 of the student B are set in pressing time field of the opinion DB 33.

In the determination process (step S78 of FIG. 9B) for the student B, the pressing time of “eight (8)” seconds is longer than the threshold time of “five (5)” seconds and thus, the student B is determined as having the truly “completely the same” opinion as that of the student A by the processing unit for student terminal 70 and the opinion flag “1” of the student B is maintained as it is (*c: upon determination). Thereafter, when the opinion list 812 is redisplayed in the shared screen 8 (*d: re-displaying), the opinion flag of the student B indicates the number “1”. Upon redisplaying the shared screen 8 (FIG. 8), the opinion of the student B is masked by the processing unit for teacher terminal 50 (step S60 of FIG. 9B) and exempted from the next candidates for presentation.

The student C having the student ID “ST003” has an “approval” for the assignment and expresses an opinion of “If we all help together, there will be no problems.” (step S72 of FIG. 9B). Due to this opinion, the student C is determined as having the same opinion as that of the student A by the processing unit for teacher terminal 50 and thus, the opinion flag of the student C is set as “0” (*a: upon designation: step S55 of FIG. 9A).

Further, the student C selects the “completely the same” button 243 in the same opinion communication screen 24 (FIG. 6) displayed due to the determination that the student C has the same opinion as that of the student A (*b: upon pressing). The opinion flag of the student C is set as “1” by the processing unit for student terminal 70 (step S75 of FIG. 9B).

The time until the student C presses the “completely the same” button 243 after the same opinion communication screen 24 (FIG. 6) is displayed in the student terminal 3 of the student C is measured by the processing unit for student terminal 70 and the measured value is stored in the pressing time (step S77 of FIG. 9B). “two (2)” seconds measured in the student terminal 3 of the student C are set in pressing time field of the opinion DB 33.

In the determination process (step S78 of FIG. 9B) for the student C, the pressing time of “two (2)” seconds is shorter than the threshold time of “five (5)” seconds and thus, the student C is determined as having the false “completely the same” opinion as that of the student A by the processing unit for student terminal 70 and the opinion flag “1” of the student C is changed to a symbol “-” (null) which indicates non-setting (*c: upon determination). Thereafter, when the opinion list 812 is redisplayed in the shared screen 8 (*d: re-displaying), the opinion flag of the student C indicates the symbol “-”. Upon redisplaying (*d: re-displaying) the shared screen 8 (FIG. 8), the opinion of the student C is not masked (step S60 of FIG. 9B). The student C becomes the next candidates for presentation.

The student D having the student ID of “ST004” has an “approval” for the assignment and expresses an opinion of “It may be used for burial.” (step S72 of FIG. 9A). Due to this opinion, the student D is determined as having the same opinion as that of the student A by the processing unit for teacher terminal 50 and thus, the opinion flag of the student D is set as “0” (*a: upon designation: step S55 of FIG. 9A).

Further, the student D did not select any one of the buttons 243, 244, 245 during displaying of the shared screen 8 in an enlarged scale in the same opinion communication screen 24 (FIG. 6) displayed due to the determination that the student D has the same opinion as that of the student A (*b: upon pressing). The opinion flag of the student D is erased and changed to the symbol “-” (null), which indicates non-setting, by the processing unit for student terminal 70 (step S75 of FIG. 9B).

The opinion flag of the student D is not “1” and thus, a determination process for the student D is not performed by the processing unit for student terminal 70. Thereafter, when the opinion list 812 is redisplayed in the shared screen 8 (“*d: upon re-displaying”), the opinion flag of the student D indicates the symbol “-” (null) which indicates non-setting. The opinion flag of the student D is not masked (step S60 of FIG. 9B) upon re-displaying of the shared screen 8 (FIG. 8). The student D becomes the next candidate for presentation.

The student E having the student ID of “ST005” has an “approval” for the assignment and expresses an opinion of “There is no difference between us. A disaster due to earthquake may occur anywhere.” (step S72 of FIG. 9A). Due to this opinion, the student E is determined as having the same opinion as that of the student A by the processing unit for teacher terminal 50 and thus, the opinion flag of the student E is set as “0” (*a: upon designation: step S55 of FIG. 9A).

Further, the student E selects the “want to supplement” button 244 in the same opinion communication screen 24 (FIG. 6) displayed due to the determination that the student E has the same opinion as that of the student A (*b: upon pressing). The opinion flag of the student E is set as “2” by the processing unit for student terminal 70 (step S75 of FIG. 9B).

Since the opinion flag of the student E does not indicate “1”, that is, the student E did not press the “completely the same” button 243, a process of storing the measured “pressing time” (step S77 of FIG. 9B) and the determination process (step S78 of FIG. 9B) are suppressed and are not performed.

Thereafter, when the opinion list 812 is redisplayed in the shared screen 8, the opinion flag of the student E indicates “2”. Upon redisplaying (*d: re-displaying) of the shared screen 8, the opinion of the student E is not masked (step S60 of FIG. 9B). The student E becomes the next candidate for presentation.

The student F having the student ID of “ST006” has a “disapproval” for the assignment and expresses an opinion of “There is a problem of the space. There will be no remaining spaces.” (step S72 of FIG. 9A). Due to this opinion, the student F is determined as having an opinion different from that of the student A and thus, no value is set in the opinion flag, that is, the opinion flag of the student F maintains an unset state (*a: upon designation: step S55 of FIG. 9A).

Further, events of the “*b: upon pressing” and the “*c: upon determination” do not exist in a processing for the student A due to the determination that the opinion of the student F is different from that of the student A. Accordingly, the opinion flag of the student F is not changed. Accordingly, the opinion flag of the student F maintains the unset state at “*d: upon redisplaying”. That is, the opinion of the student F is not masked (step S60 of FIG. 9B) upon redisplaying the shared screen 8 (“*d: upon re-displaying”). The student F becomes the next candidate for presentation.

The processing for the student G and the student H are the same as that of the student F and thus, description thereof will be omitted. The opinions of the student G and student H are not masked (step S60 of FIG. 9B) upon redisplaying of the shared screen 8 (“*d: upon re-displaying”). The student G and the student H become the next candidates for presentation.

As a result, the students C, D, E, F, G and H are displayed to be easily discernible as the next candidates for presentation upon redisplaying of the shared screen 8 (FIG. 8) except for the student A who is the presenter and the student B who has expressed his opinion as the true “completely the same” as the opinion presented by the student A.

In a case where a presenter selection support process according to the embodiment as described above is not performed, when the number of enrolled students of a class is multiple (e.g., forty (40) students), the teacher 1t is not easily able to group the students 3c having the same opinion. Accordingly, the teacher 1t arbitrarily selects each student 3s one by one among forty (40) students 3s on the opinion list 812 of the shared screen 8, and either reads the opinion of each student 3s or causes the student to present his opinion. Since time is wasted by merely grasping the contents of the opinions of the students, it may be difficult to efficiently collect opinions of all the students within a class hour.

Further, in a case where the teacher 1t actually designates and causes a student 3s to present his opinion, the student 3s may express as “I have the same opinion as that of Mr. XX.” and thus, time may be wasted when an attempt to cover various opinions is made. Further, there is a student (who corresponds to the student C having the false “completely the same” opinion as that of the student A in the embodiment described above) who expresses his opinion easily as “I have the same opinion as that of Mr. XX.” to avoid presenting his opinion though the student 3s has a different viewpoint, among the students 3s who speak such a statement.

However, in a case where the presenter narrowing process according to the embodiment is applied, when an item indicating that an opinion is the same as a designated opinion is satisfied for a predetermined basis to be selected from choices regarding the opinion designated from a plurality of collected opinions, the opinion inputted in a terminal in which the item is selected may be determined as the truly same opinion as the designated opinion, and it becomes possible to narrow presenter candidates having different opinions.

Only the opinion of the student 3s having the truly “same opinion” as that of a current presenter is displayed, for example, in masking and thus, the teacher 1t may exclude the student 3s who has the truly “same opinion” from the next presenter candidates. The teacher 1t may efficiently designate a plurality of students 3s who have various opinions within a class hour.

Further, in the present embodiment, by determining whether an opinion is the truly “completely the same” or the falsely “completely the same” as the opinion being presented, an opportunity to present an opinion may be given to a student 3s other than the students 3s who have the truly “completely the same” opinion as much as possible and thus, learning effect of each student 3s may be enhanced by listening to various opinions.

From the matters described above, the embodiment may be summarized as follows.

(1) There is a type of class in which opinions inputted in the student terminal 3 are collected and displayed in a screen (shared screen 8) by the server 100 (or the teacher terminal 1) and a student 3s is caused to present his opinion regarding an opinion designated by manipulation of the teacher lt.

(2) In the type of class as described in paragraph (1), when the student 3s is caused to present his opinion against each of the displayed opinions, it is inefficient in use of time.

(3) In paragraph (2), in a case where several students 3s who have similar opinions exist, an efficient method of conducting the class is that one student 3s representative of several students 3s is caused to present the opinion and a student 3s who has an opinion with a certain difference in the opinion of a representative presenter among the students other than the representative presenter is caused to present the difference as supplementary matters.

(4) In the case of paragraph (3), the student 3s other than the representative presenter may present that “I have the same opinion” as that of the presenter to try to avoid presenting his opinion though the student 3s actually have some difference.

(5) In the present embodiment, in consideration of paragraph (4), when the method as described in paragraph (3) is performed, the student 3s who has an opinion different from that of the representative presenter may be automatically determined.

In a group formed by opinions being classified as the same opinions for the assignment, a presenter candidate may be appropriately indicated by allowing the truly same opinion to be easily discerned.

The present disclosure is not limited to the specific embodiments described above but various changes and modification may be made thereto without departing from scope of claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A processing apparatus comprising:
a display unit configured to display one or more opinions input from each of a plurality of terminals; and
an instruction unit configured to instruct a terminal, in which an opinion other than a designated opinion among opinions that belong to a certain group is input, to display a screen in which each of a plurality of items related to relevancy to the designated opinion is selectable when the opinion which belongs to the certain group among at least one group formed by being classified from opinions displayed in the display unit is designated,
wherein the instruction unit is configured to allow the display unit to highlight an opinion input to a terminal, for which a timing at which one item among the plurality of items is selected satisfies a predetermined criterion, among the opinions that belong to the certain group compared to the other opinions that belong to the certain group.

2. The processing apparatus according to claim 1, wherein the instruction unit is configured to allow the display unit to display an opinion which is input to a terminal, for which a timing at which the one item is selected does not satisfy a predetermined criterion, among the opinions that belong to the certain group as a next candidate for designation.

3. The processing apparatus according to claim 1, wherein the instruction unit is configured to measure a time spanning from a start of presentation of the designated opinion to an end of the presentation and calculate the predetermined criterion according to a predetermined percentage of the measured time.

4. The processing apparatus according to claim 1, wherein the instruction unit is configured to allow the display unit to display a screen which is selectable in accordance with starting of presentation of the designated opinion and to measure a time spanning from a start of displaying of the screen which is selectable to the timing at which the one item is selected.

5. A processing system comprising:
a display unit configured to display one or more opinions input from each of a plurality of terminals;
a first instruction unit configured to instruct a terminal, in which an opinion other than a designated opinion among opinions that belong to a certain group is input, to display a screen in which each of a plurality of items related to relevancy to the designated opinion is selectable when the opinion which belongs to the certain group among at least one group formed by being classified from opinions displayed in the display unit is designated; and
a second instruction unit configured to allow the terminal to display the screen which is selectable according to the instruction by the first instruction unit and allow the display unit to highlight an opinion input to a terminal, for which a timing at which one item among the plurality of items is selected satisfies a predetermined criterion, among the opinions that belong to the certain group compared to the other opinions that belong to the certain group.

6. A presenter narrowing method comprising:
displaying one or more opinions input from each of a plurality of terminals;
instructing a terminal, in which an opinion other than a designated opinion among opinions that belong to a certain group is input, to display a screen in which each of a plurality of items related to relevancy to the designated opinion is selectable when the opinion which belongs to the certain group among at least one group formed by being classified from opinions displayed in the display unit is designated; and
allowing the display unit to highlight an opinion input to a terminal, for which a timing at which one item among the plurality of items is selected satisfies a predetermined criterion, among the opinions that belong to the certain group compared to the other opinions that belong to the certain group.
